(19) United States
(12) Patent Application Publication
(10) Pub. No.: US 2025/0093851 A1
(43) Pub. Date: Mar. 20, 2025

(54) HIGHLY SCALABLE LABORATORY AND PROCESS AUTOMATION PLATFORM AND METHODS OF USE

(71) Applicant: Hur Koser, Wallingford, CT (US)

(72) Inventor: Hur Koser, Wallingford, CT (US)

(21) Appl. No.: 18/888,759

(22) Filed: Sep. 18, 2024

Related U.S. Application Data
(60) Provisional application No. 63/583,461, filed on Sep. 18, 2023.

(51) Int. Cl. G05B 19/4155

(52) U.S. Cl. CPC G05B 19/4155; G05B 2219/31392

(57) ABSTRACT

A scalable laboratory and process automation platform comprising: a first module, the first module comprising: a first instrument housing, the first instrument housing comprising: a side shell; a bottom cover attached to the bottom of the side shell, the side shell generally comprising four walls; a top cover attached to the top of the side shell; a power port located in the side shell; an upstream daisy-chain connection port located in the side shell; a downstream daisy-chain connection port located in the side shell; the first instrument housing configured to house any component from the following group of mechanical or electrical components comprising: circuit boards, sensors, motors, solenoids, solenoid valves, rotary valves, heating assemblies, piston pump, fluidic control elements like pumps or valves, pneumatic control elements, air flow controllers, vacuum/air-pressure valves, air/gas pumps, vacuum pumps, piston pump modules, fluidic valves with a piston pump head to provide bidirectional pumping capability, air pressure supply and air flow controller and pneumatic valves being combined with a fluidic manifold and valves to provide a precision liquid and droplet dispensing platform; linear motion stages, rotary motion stages, linear motion module, pump head; sensor modules, computer vision modules, motion controller modules, dispensing modules, actuator modules, linear actuators, grippers, light sensors, fluorescence meters, photomultipliers, camera sensors, microscope heads, spectrometer units, mechanical actuators, cover removers for a microwell plate, thermal incubation modules, magnetic bead extraction modules, and mixing modules; a first circuit board located inside the first instrument housing and mounted to the bottom cover, the circuit board in communication with the power port, the upstream daisy-chain connection port, the downstream daisy-chain connection port, and the component. A scalable laboratory and process automation platform comprising: a meta-instrument housing, configured to house a plurality of modules; a backplane located in the meta-instrument housing; each of the plurality of modules comprising: an instrument housing, the first instrument housing configured to house any component from the following group of mechanical or electrical components comprising: circuit boards, sensors, motors, solenoids, solenoid valves, rotary valves, heating assemblies, piston pump, fluidic control elements like pumps or valves, pneumatic control elements, air flow controllers, vacuum/air-pressure valves, air/gas pumps, vacuum pumps, piston pump modules, fluidic valves with a piston pump head to provide bidirectional pumping capability, air pressure supply and air flow controller and pneumatic valves being combined with a fluidic manifold and valves to provide a precision liquid and droplet dispensing platform; linear motion stages, rotary motion stages, linear motion module, pump head; sensor modules, computer vision modules, motion controller modules, dispensing modules, actuator modules, linear actuators, grippers, light sensors, fluorescence meters, photomultipliers, camera sensors, microscope heads, spectrometer units, mechanical actuators, cover removers for a microwell plate, thermal incubation modules, magnetic bead extraction modules, and mixing modules; where each of the modules are in communication with each other through connections with the backplane.

### CROSS-REFERENCES

This patent application claims priority to provisional patent application No. 63/583,461 filed on Sep. 18, 2023 by Hur Koser, entitled “A HIGHLY SCALABLE LABORATORY AND PROCESS AUTOMATION PLATFORM AND METHODS OF USE”, which provisional application is fully incorporated by reference herein.

### TECHNICAL FIELD

The invention relates to a highly scalable laboratory and process automation platform and methods of use, and more particularly, to a highly scalable laboratory and process automation platform and methods of use that is modular with individual modules changeable by a user.

### BACKGROUND

Each laboratory experiment or manufacturing process is unique in its need for fluid or pneumatic control. Flow rates, number of flow lines, pressure and vacuum ranges that can be accommodated, temperatures and other variables that need to be monitored vary greatly between applications. For instance, microfluidic cartridges used in single-cell experiments tend to have slow fluid flow rates (e.g., microliters per minute) across channels with micro-scale cross-sections, leading to moderate to high back pressures formed. Meanwhile, fill lines in reagent dispensing systems run through large volumes of fluid (liters per minute) within relatively large tubings as quickly as possible for efficiency and economic reasons.

With such variety of operational parameters, conventional laboratory and process equipment are highly specialized for each application niche. Instruments and equipment that provide fluidic and pneumatic flow control come in all different sizes and capabilities, and they are not readily useful outside their niche application area. For instance, a microfluidic flow controller equipment is not readily suited to act as a reagent dispensing system in a fill-line facility. As such, users with experience on a particular equipment need new training on a different system when the application context and operational parameters change.

A further complication is that each equipment from a vendor often features a custom and separate set of programming instructions, as well as methods of interfacing and automation. Potential applications in laboratory and process automation involving fluidic and pneumatic control are virtually endless, as are the command sets and automation challenges that need to be remastered by users. Even if the operational parameters remain the same, when a switch is made from one manufacturer to another within the same application space, existing automation programs will often need to be revised or rewritten-causing significant and costly delays in project setup.

Original Equipment Manufacturers (OEMs) attempt to address some of these challenges by producing a standard class of parts—such as pumps and electromechanical valves—that can be used in a multitude of instruments. Instrument manufacturers then have to either create their own control circuitry for these parts, or use the printed circuit boards (PCBs) provided by the OEMs to interface with them in the context of their own particular instrument. The common user in a laboratory or a process plant, however, typically does not possess the technical background to quickly and efficiently create their own custom instrument platform from such OEM parts. As such, even though users might already be familiar with the OEM parts used in a given equipment, they end up having to choose an equipment configuration (amongst those available in the market) that somewhat matches their needs, and to strive to make their application fit the capabilities of that equipment, instead of the other way around. Too often, the end result is either the user overpaying for extra capabilities that they did not need, or the user settling with a system that underperforms in the context of their application.

Another economic challenge in laboratory and process automation is in scaling up operations and capabilities after a smaller, proof-of-principle setup is successful. Capital equipment with high throughput is expensive to acquire, install and maintain. Such large equipment typically requires personnel with special training and education to run and service. What is more, with size, number of moving parts, and parallel lines increased, a large laboratory instrument or process equipment tends to break down or require maintenance often—which disrupts operations, reduce efficiency and overrun costs.

Thus there is a need for a highly scalable laboratory and process automation platform and methods of use that overcome the above listed and other disadvantages.

### SUMMARY OF THE INVENTION

The invention relates to a scalable laboratory and process automation platform comprising: a first module, the first module comprising: a first instrument housing, the first instrument housing comprising: a side shell; a bottom cover attached to the bottom of the side shell, the side shell generally comprising four walls; a top cover attached to the top of the side shell; a power port located in the side shell; an upstream daisy-chain connection port located in the side shell; a downstream daisy-chain connection port located in the side shell; the first instrument housing configured to house any component from the following group of mechanical or electrical components comprising: circuit boards, sensors, motors, solenoids, solenoid valves, rotary valves, heating assemblies, piston pump, fluidic control elements like pumps or valves, pneumatic control elements, air flow controllers, vacuum/air-pressure valves, air/gas pumps, vacuum pumps, piston pump modules, fluidic valves with a piston pump head to provide bidirectional pumping capability, air pressure supply and air flow controller and pneumatic valves being combined with a fluidic manifold and valves to provide a precision liquid and droplet dispensing platform; linear motion stages, rotary motion stages, linear motion module, pump head; sensor modules, computer vision modules, motion controller modules, dispensing modules, actuator modules, linear actuators, grippers, light sensors, fluorescence meters, photomultipliers, camera sensors, microscope heads, spectrometer units, mechanical actuators, cover removers for a microwell plate, thermal incubation modules, magnetic bead extraction modules, and mixing modules; a first circuit board located inside the first instrument housing and mounted to the bottom cover, the circuit board in communication with the power port, the upstream daisy-chain connection port, the downstream daisy-chain connection port, and the component.

The invention also relates to a scalable laboratory and process automation platform comprising: a meta-instrument housing, configured to house a plurality of modules; a backplane located in the meta-instrument housing; each of the plurality of modules comprising: an instrument housing, the first instrument housing configured to house any component from the following group of mechanical or electrical components comprising: circuit boards, sensors, motors, solenoids, solenoid valves, rotary valves, heating assemblies, piston pump, fluidic control elements like pumps or valves, pneumatic control elements, air flow controllers, vacuum/air-pressure valves, air/gas pumps, vacuum pumps, piston pump modules, fluidic valves with a piston pump head to provide bidirectional pumping capability, air pressure supply and air flow controller and pneumatic valves being combined with a fluidic manifold and valves to provide a precision liquid and droplet dispensing platform; linear motion stages, rotary motion stages, linear motion module, pump head; sensor modules, computer vision modules, motion controller modules, dispensing modules, actuator modules, linear actuators, grippers, light sensors, fluorescence meters, photomultipliers, camera sensors, microscope heads, spectrometer units, mechanical actuators, cover removers for a microwell plate, thermal incubation modules, magnetic bead extraction modules, and mixing modules; where each of the modules are in communication with each other through connections with the backplane.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective depiction of an exemplary embodiment of a unit instrument housing;

FIG. 2 illustrates an exemplary peristaltic pump within the unit housing;

FIG. 3 depicts the electrical and data connection ports of the exemplary unit;

FIG. 4 is a schematic illustration of an exemplary unit electrical circuit board;

FIG. 5A is a depiction of multiple instrument units being daisy-chained to form a meta-instrument;

FIG. 5B is a schematic illustration of a simple linear daisy-chain of units with a single bus layer between neighboring modules;

FIG. 5C is a schematic illustration of a daisy-chain of modules, featuring a standard linear, two-way serial bus, in addition to the inter-module bus in FIG. 5B;

FIG. 5D illustrates a three bus system that provides separate lines of communication for commands from the leader, versus responses and data from the followers;

FIG. 6 shows a larger pump module with a longer unit instrument housing designed to accommodate the larger motor of a high volume OEM peristaltic pump;

FIG. 7 depicts an exemplary piston pump module that uses the common instrument housing design, featuring an OEM piston pump unit (with inlet and outlet ports) and associated priming and outlet valves;

FIG. 8 is a perspective illustration of an exemplary solenoid valve module in the exemplary instrument housing;

FIG. 9 shows the exemplary solenoid valve manifold assembly by itself;

FIG. 10a illustrates an exemplary rotary valve module within the exemplary housing, featuring an OEM rotary valve with one inlet port and 12 outlet ports;

FIG. 10b shows an actuator module in the housing;

FIG. 10c shows the bottom side of the housing from FIG. 10b;

FIG. 11 is an exemplary depiction of a plug-and-play meta-instrument inside its own larger housing, comprised of four peristaltic pump modules, with power and communication connections automatically set up within the meta-instrument housing;

FIG. 12 is another exemplary depiction of a four-unit meta-instrument in its own housing, with two piston pumps and two rotary valve modules;

FIG. 13 is an exemplary plate handler setup with multiple dispensing and sensing ports, and with the four-unit instrument from FIG. 12 providing fluidic input;

FIG. 14 shows an exemplary software with a graphical user interface (GUI) that displays which units are connected and provides a simple way to interact with them;

FIG. 15 depicts an exemplary GUI window which, when an individual module is selected, displays a corresponding virtual control panel for that module;

FIG. 16 illustrates the software providing real-time feedback in operational parameters to the user on the virtual control panel as a selected peristaltic pump unit runs a unit task;

FIG. 17 depicts an exemplary GUI window, in which the operational parameters of a selected instrument module may be easily translated to a line of code for rapid automation purposes;

FIG. 18 shows an exemplary GUI window that demonstrates the capability to easily program a network of instrument modules, with lines of code inside the assay script box being highlighted (in blue) in real-time as they are executed; and

FIG. 19 illustrates an exemplary GUI window and its main menu with an option to use artificial intelligence to provide scripting options or suggest code fixes for the user's programming effort.

### DETAILED DESCRIPTION

One embodiment of the disclosed platform is a platform that the users can easily build from the ground up, using OEM parts that meet their application needs, without having to design custom control circuitry or write a sophisticated control program in a real-time operating system. The disclosed platform, system, method and apparatus may provide fluidic and pneumatic control, actuation and sensing support for laboratory and process automation applications in a simple, highly cost-effective manner while providing flexibility, extreme ease-of-programming, and support at all scales of operation—from the manual, proof-of-principle experimentation setup to industrial-scale automation. Such an approach may be even more useful as a platform comprised of small, simple, and modular components that can be readily and easily combined to exponentially scale up experimental or processing capabilities. Each modular unit, or module, may focus on either a single or a small set of control or sensing tasks, utilizing either OEM or custom parts for those tasks. Each modular unit may be independently controllable using a virtual instrument control panel on any type of computer (desktop, portable, mobile or cloud) running on any widely-available operating system. The platform would generally require no additional hardware to control a modular unit, supporting instead a very simple interface that is readily available with the computer—including, but not limited to, USB, WiFi or Bluetooth—to communicate with the unit.

In an embodiment, each modular instrument unit is housed in a shell that shares common dimensional and functional attributes across the different instrument types. This approach reduces part counts associated with the overall platform, providing a more cost-effective manufacturing option and compatibility across the various instrument units.

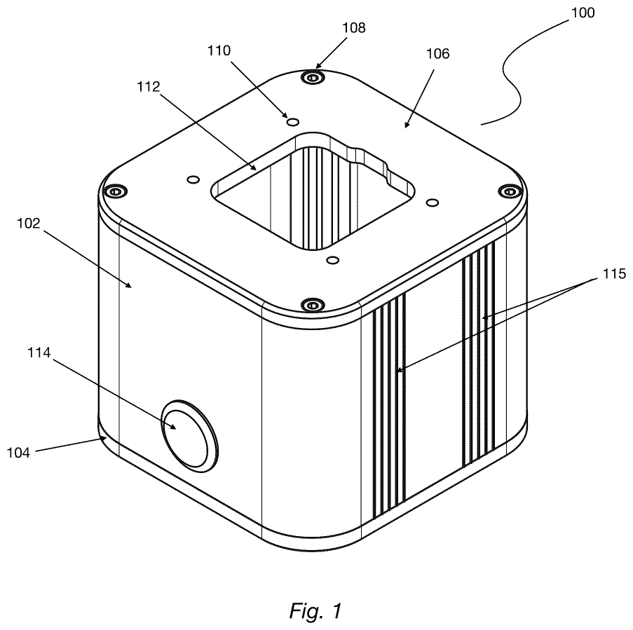

FIG. 1 is a perspective depiction of an exemplary embodiment of an instrument housing 100 that can be common to most units. This embodiment is comprised of a side shell 102 that is encapsulated by a bottom cover 104 and a top cover 106. The side shell 102 may comprise four walls that are in communication with one an other. In one embodiment, side shell 102 may be made out of extruded aluminum, with the covers milled out of plate aluminum, with all parts anodized for durability, ease-of-cleaning and chemical resistance—all desirable aspects for instruments operating in a laboratory or factory environment. In another embodiment, the housing shell parts may be made out of injection-molded plastic. In an embodiment, the inside of the housing 100 may be intended for the mechanical and electrical components of the instrument unit, whereas the outside (typically above the top cover 106) may be reserved for the fluidic parts and the ports with which the user interacts. In this fashion, the electrical and mechanical components (such as circuit boards, sensors, motors, solenoids, etc.) of the unit may be protected from accidental fluid leaks, harsh cleaning solutions and other chemicals, as well as inadvertent meddling by the user, who may focus their attention only to the fluidic connections that they wish to make.

Top cover 106 may feature screw holes 108 for attaching to the rest of the housing, as well as screw holes 110 and openings 112 to accommodate the mounting of a functional OEM component (for instance, a peristaltic pump). In certain embodiments, top cover 106 may be oversized compared to the side shell 102 so that the instrument may be mounted on a wall panel or bench top enclosure. In an embodiment, the housing 100 might also feature a prominently placed power switch 114 with light that makes it easy to tell when the instrument is turned on. In another embodiment, the power switch may be separate from the power-on light. In yet another embodiment, the unit housing may accommodate a screen (such as an LED, LCD or an electronic ink screen) to display simple information, such as the position of a given unit within a daisy-chain. The housing may also feature side ridges 115 to provide a surface that is easy to grip.

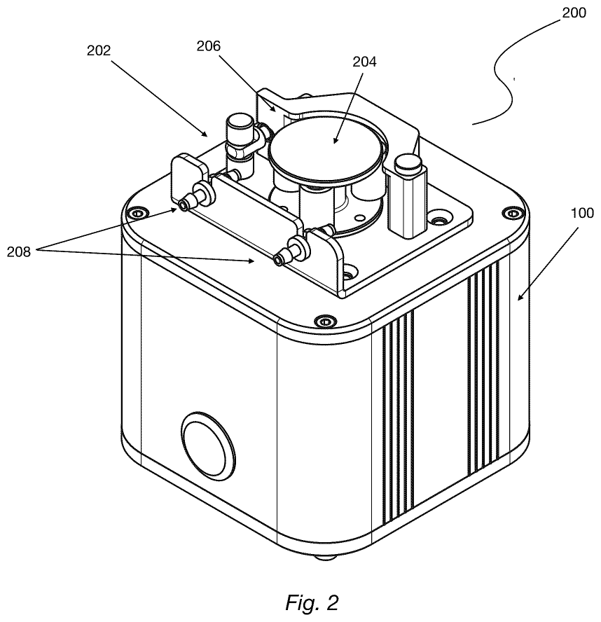

FIG. 2 illustrates an exemplary peristaltic pump unit 200, obtained by encapsulating an OEM peristaltic pump 202 within the instrument housing 100 depicted in FIG. 1. In an embodiment, the roller head 204 and the compression lever 206 are outside the housing and accessible to the user, as are tubing connectors 208 that might be present. In another embodiment, the fluidic tubing may directly interface with the pump head without the need for any connectors. The motor that drives the roller head may be inside the instrument housing 100, as may be any electrical connectors, temperature sensors, encoders and auxiliary mechanical and electrical components.

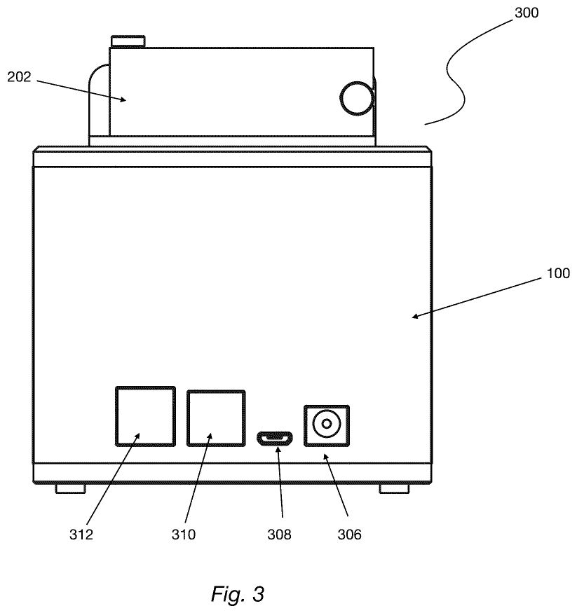

FIG. 3 depicts the electrical and data connection ports of an embodiment of exemplary unit 200, featuring the peristaltic pump head 202 from FIG. 2 attached to the housing 100. In an embodiment, the connections to the modular instrument unit may include a direct current (DC) power port 306, a USB port 308, an upstream daisy-chain connection port 310, and a downstream daisy-chain connection port 312. Other embodiments may include additional connection ports, including, but not limited to, sensor inputs, diagnostic ports and video monitor outputs. In an embodiment, a given instrument module is controllable directly via USB, or via the daisy-chain connection within an instrument network. The daisy-chain connection may be a simple two-wire serial network in its hardware implementation, such as RS232 or RS485, facilitated via existing cable assemblies (such as shielded Ethernet cables for robust signal transduction in an otherwise electrically noisy factory floor, or simple phone cables for low-cost research laboratory use) and connector heads (such as RJ12) to reduce cost.

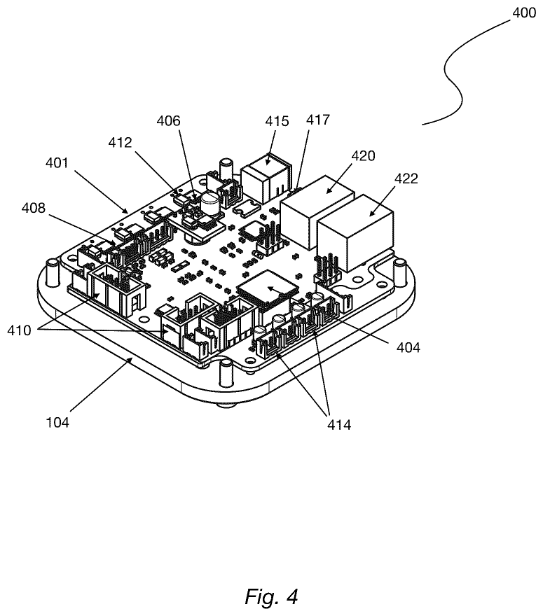

FIG. 4 is a schematic illustration 400 of an exemplary unit electrical circuit board 401 mounted over the bottom cover plate 104. In an embodiment, a main microcontroller or microprocessor 404 controls all the motion and monitors all the sensors associated with that instrument unit; it also coordinates the communication with an external computer and/or other instrument units within its daisy-chain. An embodiment may include a DC-to-DC converter subsystem 406, a motor driver subsystem and its connectors 408, digital and analog input/output ports 410, additional drivers for high current tasks 412—such as solenoid valves, heating assemblies, etc., as well as sensor ports 414 for temperature and other operational variables. The circuit board 401 in an embodiment may also include a DC power input port 415, a USB port 417 to communicate with an external computer or controller, an upstream daisy-chain port 420 and a downstream daisy-chain port 422 to communicate with other modules in the network. Other embodiments of the circuit board may feature wireless communication subsystems, such as WiFi or Bluetooth.

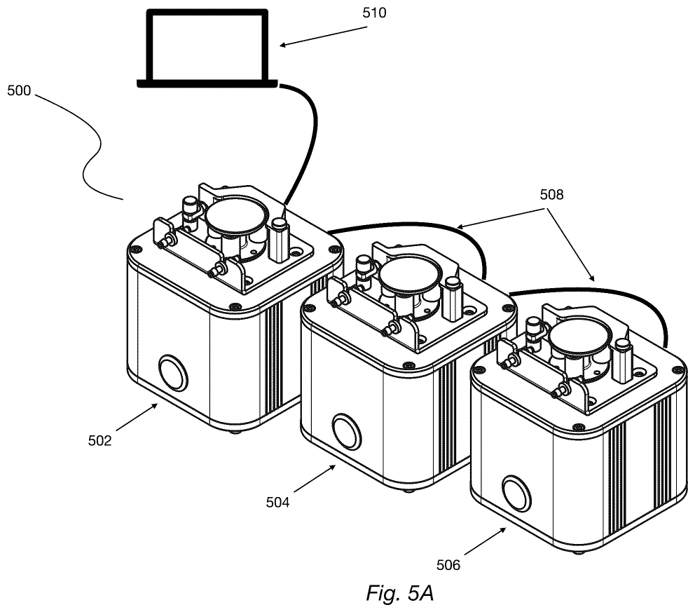

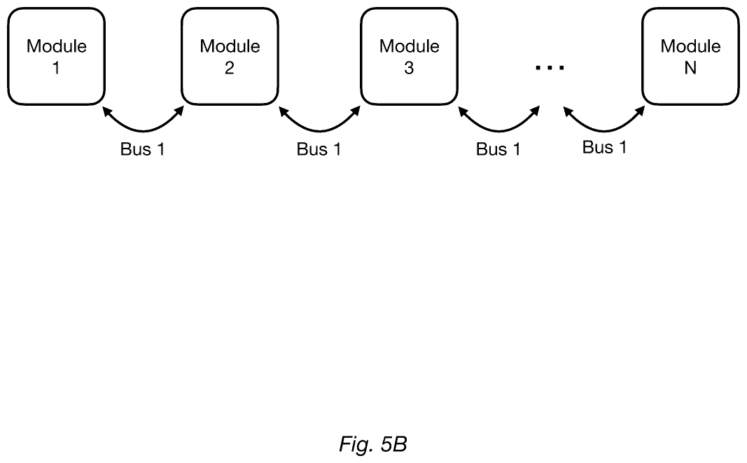

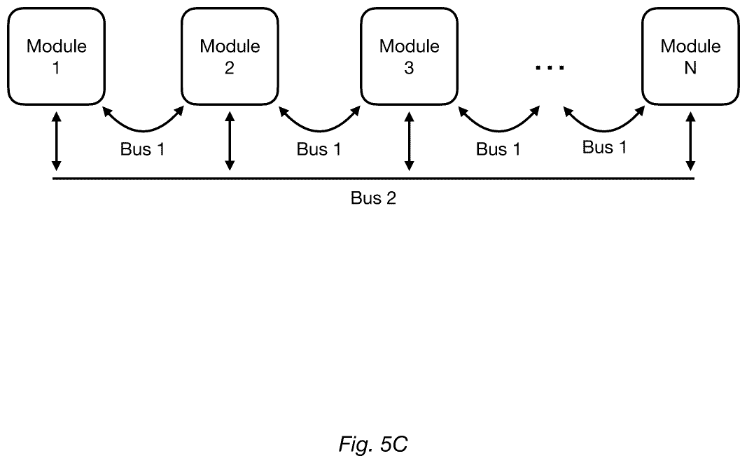

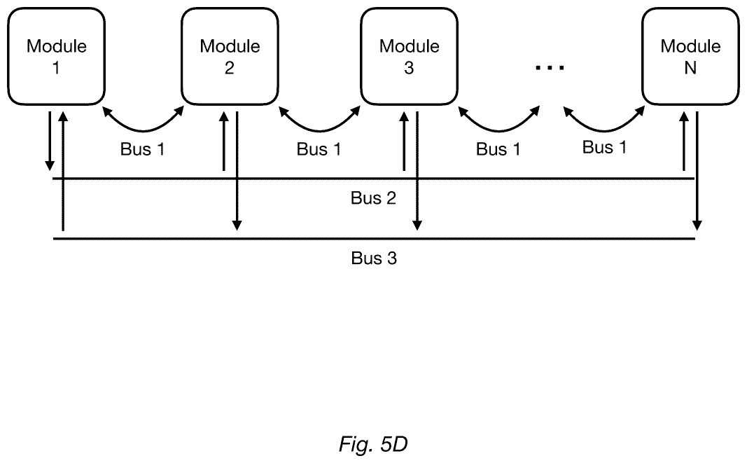

FIG. 5A is a depiction of multiple instrument units being daisy-chained to form a meta-instrument 500. The first or “leader” module 502 of the meta-instrument may be connected to a computer, smartphone or tablet via USB, while the downstream or “follower” modules 504 and 506 are daisy-chained to form a linear network. Each of the modules 502, 504, 506, etc. may comprise an instrument housing 100 that houses or is connected to a mechanical and electrical component. In other embodiments, the leader may be connected to a computer, phone or tablet via WiFi or Bluetooth. In an embodiment, instruments may be connected in a linear network configuration in any order, with the leader taking responsibility for coordinating the “handshake” within the daisy-chain network modules. When the leader is prompted by the external computer, it initiates a roll call across the linear network, with each module taking turns to automatically assume a network address number that increments up along the line of modules within the daisy-chain. In this embodiment, the daisy-chain of modules requires no specialized external controller—i.e., no additional hardware for the computer to interface with or for the user to have to obtain, unlike other systems that can be chained such as GPIB or PXI. In addition, each instrument in the daisy-chain is fully replaceable by another (either the same or a different type of module), and it automatically obtains the same address as that of the module it replaces. The serial cables 508 that connect the modules can be as long as the specific hardware implementation allows while mitigating voltage drop and noise issues—in an embodiment using RS485 hardware, cable length may exceed 1 km, depending on the data rate chosen. Combined with the automatic addressing and ease of replacement features of a module, the resulting meta-instrument may be contained on a bench top, or span an entire processing plant floor.

FIG. 5B is a schematic illustration of a simple linear daisy-chain of units with a single bus layer between neighboring modules. For simplicity and clarity, the controlling computer, smartphone or tablet is omitted from the figure, but it is assumed to be connected to the first module. In this exemplary embodiment, the RS485 driver/receiver chips may be used to drive a pair of wires differentially to facilitate communication between neighboring modules. In these and related embodiments, the first module may receive a roll call command from the computer, which lets it know that it is the first module in the network. Module 1 may subsequently send a request to its downstream neighbor, or “follower”, via bus 1—typically a two-wire differential serial bus in an embodiment—to set its address to 2. Once Module 2 sets its address (and any termination resistances needed to mitigate reflection and noise issues in the bus), it requests its own follower to set its address to 3. Each module in the linear network takes its turn through the roll call, until the last module (Module N in FIG. 5B) does not get a reply from a follower in a prescribed amount of time (such as, in one second or an appreciable fraction of a second). In that case, the last module sets its address (and termination resistance, if needed) and reports the total number of instruments in the network up the instrument chain. Commands and responses between the leader module and the followers obey a specific pattern which includes the target instrument address. If a given module receives an instruction on the bus, it first checks the target address. If the receiving module is the target, it executes the command and issues a reply to the leader, as necessary; otherwise, the module simply passes the instruction up or down the chain. Instructions received from downstream are passed upstream, and vice versa.

The architecture depicted in FIG. 5B can be implemented to be robust and reliable, but it may also suffer from lag that will be, on average, directly related to the total number of modules in the network. Each instruction received and passed on by a module will add a small amount of lag (typically from tens of microseconds to tens of milliseconds, depending on the clock speed of each module's microcontrollers/microprocessors, as well as the communication speed set on the bus. For implementations that require more precise control on the execution timing of each instruction, another bus may be added to the architecture of the network. FIG. 5C is a schematic illustration of a daisy-chain of modules, featuring a standard linear, two-way serial bus, in addition to the inter-module bus in FIG. 5B. In this embodiment, the roll call algorithm may still rely on Bus 1 to reliably increment addresses, but the instructions from the leader to the followers may be transmitted on Bus 2, which need not suffer from accumulative lag as Bus 1 does. In this embodiment, followers may use Bus 2 to report on status and data when instructed and waited upon by the leader. Asynchronous data, such as a spontaneous error code that is not explicitly requested by the leader, may still be reported on Bus 1.

FIG. 5D illustrates a three bus system that provides separate lines of communication for commands from the leader, versus responses and data from the followers. In this embodiment, Bus 2 may be reserved for commands from the leader (with all other modules listening on Bus 2), whereas Bus 3 may be reserved for responses and data from the followers (with the leader listening on Bus 3). This embodiment may allow the leader to control other modules on Bus 2 even while a given module may be reporting a lengthy dataset on Bus 3.

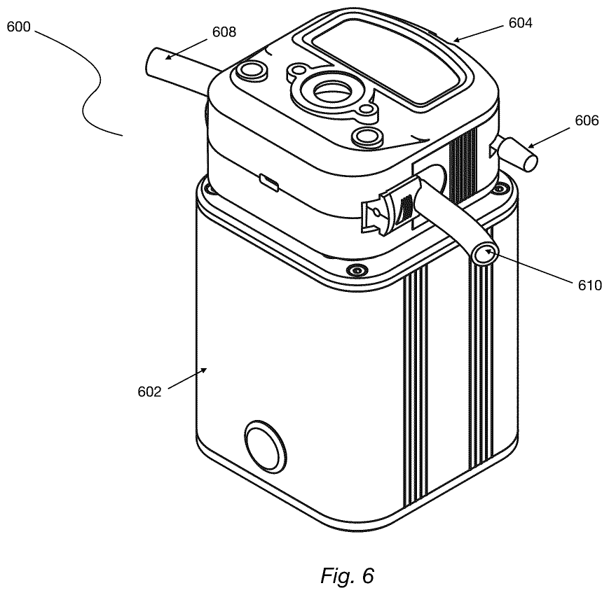

FIG. 6 shows a larger pump module 600 with a longer housing 602 designed to accommodate the larger motor of a high volume OEM peristaltic pump 604. In this example embodiment, the OEM pump head features a clamping lever 606 that pinches both the left side 608 and right side 610 of a large diameter flexible tubing, holding it in place while the rollers inside the head achieve peristalsis. In an embodiment, the longer housing 602 has the same cross-sectional dimensions (e.g., the bottom cover has the same dimensions) as the other module housing 100, so it can be mounted on the same fixtures. In other embodiments, the top and bottom covers have leg-like features protruding from the front and sides to enable the module to rest on its front side, with the power button shown in FIG. 6 facing down. In yet other embodiments, an external support fixture enables the module to lie on its front side.

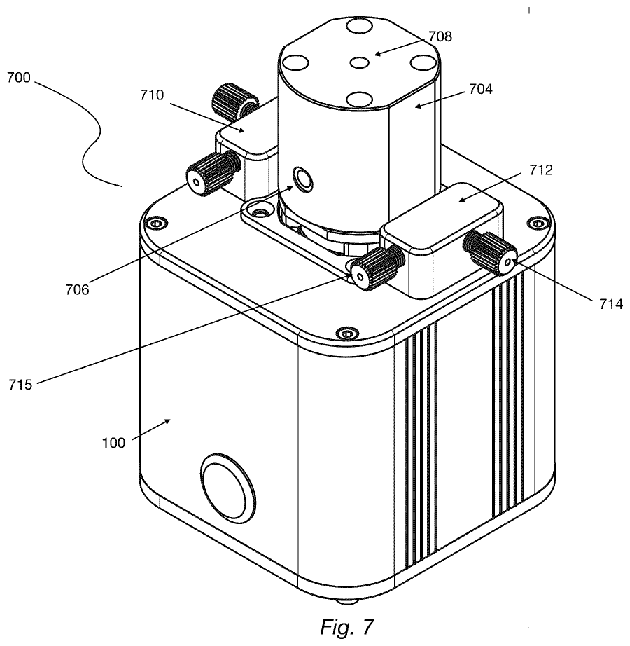

FIG. 7 depicts an exemplary piston pump module 700 that uses the common instrument housing 100, featuring an OEM piston pump unit 704 (with inlet 706 and outlet 708 ports) and associated priming 710 and outlet 712 valve manifolds. In an embodiment for this module, there may be separate, two-way inlet and outlet valves for maximum operational flexibility, as depicted in FIG. 7. In other embodiments, there may be a single, three-way valve that connects a common port of the piston pump head to inlet and outlet ports. In an embodiment, the valves used are solenoid valves; in other embodiments, the valves might be rotary valves with any number of ports, depending on the application. Fittings (e.g., 714 and 715) may be used to connect fluidic tubing to the piston pump head and the valve manifolds. In an embodiment, the valves may be operated either together with the piston pump—enabling aspiration and dispensing cycles from either manifold side—or they may be run individually and separately to utilize the module as a valve block only.

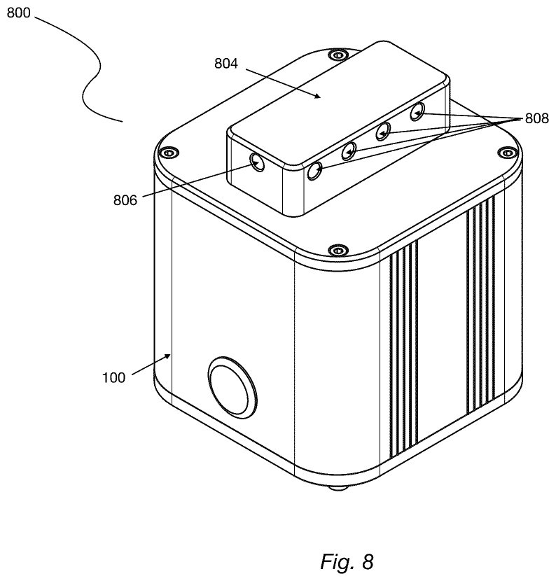

FIG. 8 is a perspective illustration of an exemplary solenoid valve module 800 in the exemplary instrument housing 100. In an embodiment, the valve manifold 804 may house 8 two-way solenoid valves, with a common port 806 and the valve ports 808 acting as individual inlets/outlets. The valve ports are accessible to the user via fittings and tubings of appropriate size. The valve manifold 804 may be machined out of a variety of materials, including, in an embodiment, out of a chemically inert or resistive material such as poly-ether-ether-ketone (PEEK) or poly-tetra-fluoro-ethylene (PTFE), but it could also be made out of acrylic for non-solvent fluids, or stainless steel for applications not using strong acids or bases.

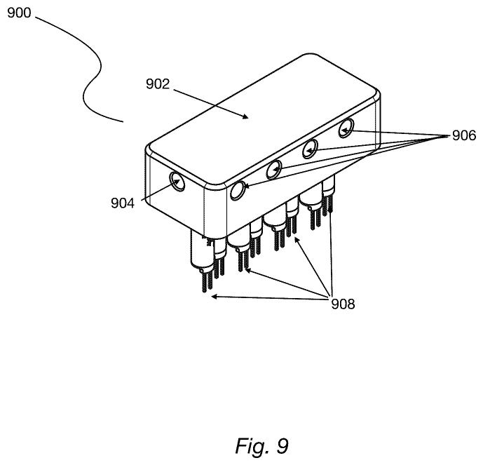

FIG. 9 shows the exemplary solenoid valve manifold assembly 900 by itself. In an embodiment, the valve manifold 902 with its common 904 and inlet/outlet 906 ports may be populated with eight two-way solenoid valves 908, each one controlling the connection between the common port and one corresponding inlet/outlet port. In a different embodiment, the manifold may be configured to have about eight separate inlets and eight corresponding outlets. In other embodiments, there may be more or fewer inlets and outlets. In other embodiments, the manifold may have a custom routing between the inlet(s) and the outlet(s)—such manifolds may be made using multi-layer bonding of certain plastics that are individually machined. In keeping with an embodiment for these modules, the solenoid valves may be placed under the manifold and enclosed within the instrument housing, enabling the user to only focus on fluidic connections on the top side of the unit.

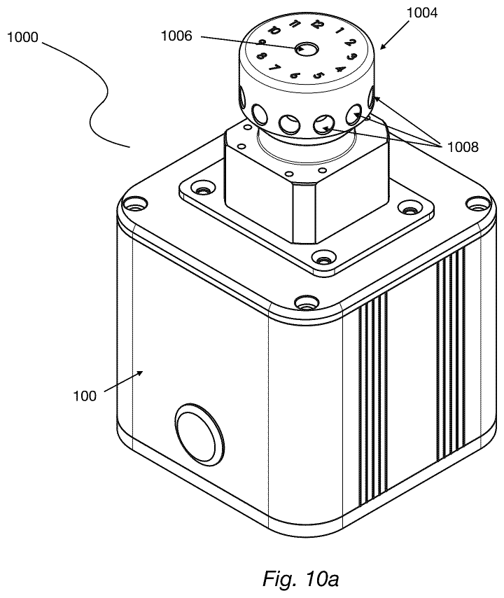

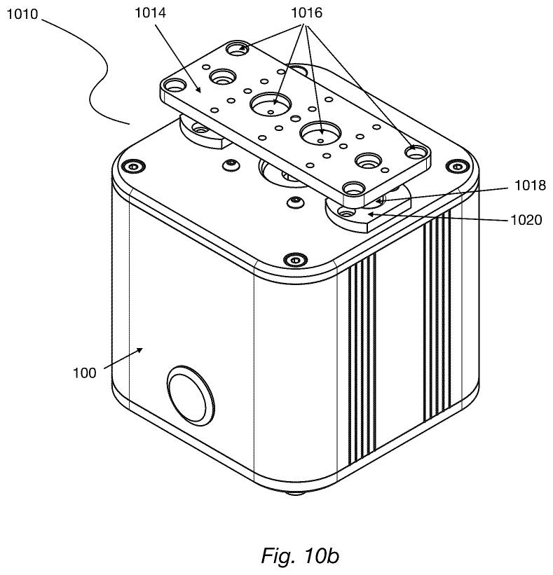

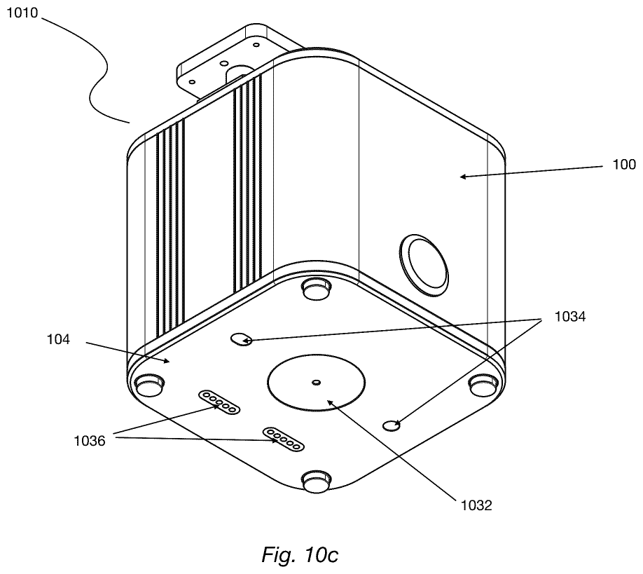

FIG. 10a illustrates an exemplary rotary valve module 1000 within the exemplary housing 100, featuring an OEM rotary valve 1004 with one inlet port 1006 and 12 outlet ports 1008. As in many embodiments, this OEM unit has fluidic ports and components sitting outside the module housing, with the motor, encoder and end-stop sensor residing inside the housing.

FIG. 10b depicts a vertical actuator module within the exemplary housing 100. In an embodiment, the actuator may move up and down a small platform 1014 and a payload mounted on it through screw holes or magnets 1016. In an embodiment, the platform 1014 may be attached to rail shafts that travel through bushings 1020. In a different embodiment, the platform may move via a different mechanical system, such as a scissor table. In some embodiments, the actuator may use electromechanical actuators to achieve motion. In yet other embodiments, the actuator module may use pneumatics to push and pull the moving stage. In an embodiment, the vertical actuator module may move a small payload up and down, and may offer the capability to be configured to achieve multiple different tasks. For instance, it may be configured to shuttle magnets closer to a sample holder (such as a 96 well plate) for magnetic bead purification and sample enrichment. The same module may be set up to bring a sensor head closer to the sample holder for measurements. It may also bring a sample plate in or out of focus of a microscope objective. It may even bring heating stages into contact with a sample holder for applications requiring temperature control of samples in a vessel or microwell plate.

FIG. 10c shows an example bottom side of the exemplary housing 100. Here, the vertical actuator module 1010 is depicted as an example, but the same bottom side 104 may be used for various other or all housings 100. In an embodiment, the bottom side of the instrument enclosure features a magnetizable steel disc 1032 mounted at the center, allowing the instrument module to be inserted into a housing and held in place by the use of either permanent or electromagnets. Alignment holes 1034 may be used to enable an optional precision alignment with the housing using fixture posts that mate with those holes. In some embodiments, electrical contacts 1036 may be utilized on the bottom cover 104 to enable plug-and-play functionality with an external hub, which would provide power and data communication connectivity with this and neighboring modules. In such embodiments, the instrument, when inserted into the hub, would not require the user to plug any cables directly to it, providing a clean, plug-and-play interface.

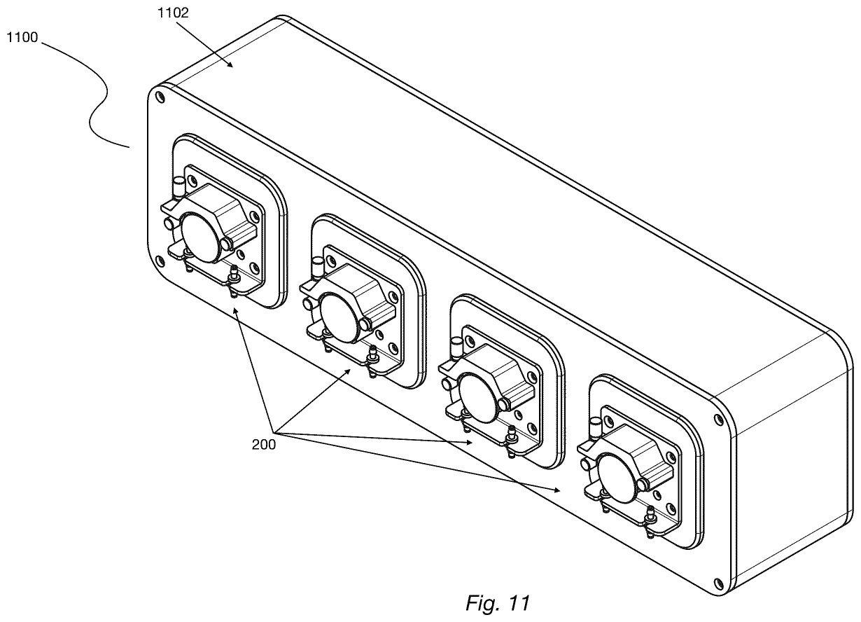

FIG. 11 is an exemplary depiction of a plug-and-play meta-instrument 1100 inside its own larger housing 1102, comprised of four peristaltic pump modules 200, with power and communication connections automatically set up within the meta-instrument housing. In an embodiment, the individual pump modules may feature specialized, recessed and protected connectors through their bottom covers, interfacing with backplane connectors within the meta-instrument housing. This arrangement is similar to how computer blades attach to server racks in database centers. In an embodiment, the backend connections may be setup to accommodate a daisy-chain amongst the pump modules from left-to-right, obviating the need to manually connect them with external cables. In some embodiments, the meta-instrument housing 1102 may incorporate a DC power supply with appropriate output voltage and sufficient output current to power up all four modules at the same time. In one embodiment, the meta-instrument housing itself does not contain any microprocessor or microcontroller that interfaces with an external computer; instead, the lead instrument's USB port is mirrored on the back side of the meta-instrument housing. In other embodiments, there is computing power included within the meta-instrument housing in order to provide sensor (such as temperature) and operational data to the computer. In yet other embodiments, the housing may include a cooling fan. In an embodiment, the meta-instrument housing provides an AC power inlet, a USB port that controls the leader, an upstream serial port and a downstream serial port—rendering the meta-instrument itself a module that can interface with other individual modules or meta-instruments.

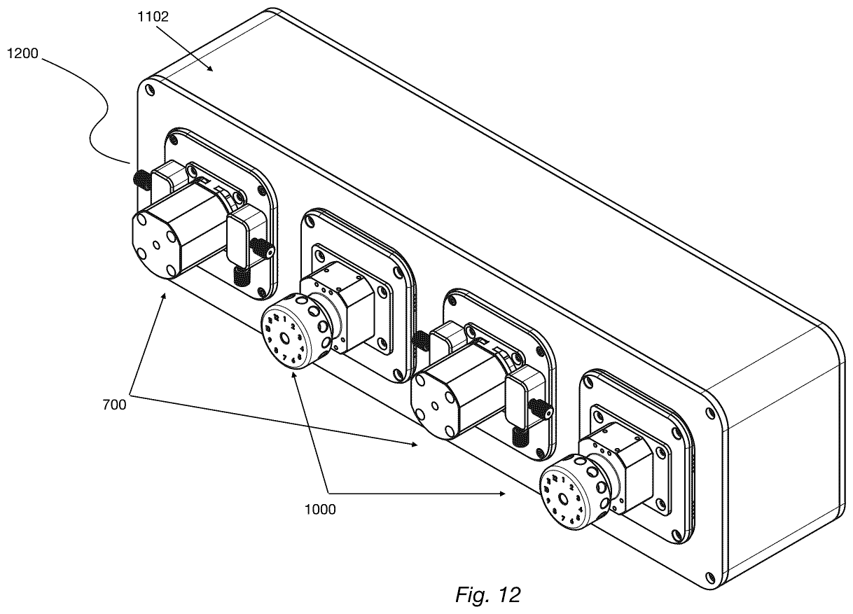

FIG. 12 is another exemplary depiction of a four-unit meta-instrument 1200 in its own housing 1102, with two piston pumps modules 700 and two rotary valve modules 1000. Being able to mix and match the various individual modules inside a meta-instrument enables the user to meet a wide variety of custom fluidic needs and novel application requirements in a self-contained, neat package. Meta-instruments may also offer a convenient and rapid means to simultaneously test the capabilities of different OEM parts and ascertain how they work together in a system. Some embodiments may involve the use of meta-instruments at various assembly, testing, filling or other process stations in a manufacturing or testing facility; as such, each station may utilize one or more meta-instruments during its processes, and every meta-instrument can eventually be controlled and monitored from a single computer. Meta-instruments, such like the individual modules, may be used on bench tops or on shelves; they may be mounted on wall panels using magnetic or mechanical attachments and fasteners; they may also be stacked on top of each other to create larger instrument assemblies.

In some embodiments, instrument modules may be fluidic control elements like pumps or valves; in others, modules may incorporate pneumatic control elements—such as air flow controllers, vacuum/air-pressure valves, air/gas pumps or vacuum pumps, etc. Some modules may combine multiple elements together to achieve new functionality—such as the piston pump module depicted in FIG. 7 that combines fluidic valves with a piston pump head to provide bidirectional pumping capability. In some embodiments, pneumatic and fluidic components may be combined for better performance—such as an air pressure supply, air flow controller and pneumatic valves being combined with a fluidic manifold and valves to provide a precision liquid and droplet dispensing platform.

In yet other embodiments, instrument modules may incorporate linear or rotary motion stages. For example, in some embodiments, an x-y stage may move a microwell plate or a tray of vials under a dispensing head connected to a separate pump module, turning the system into a plate handler. In some other embodiments, the dispensing head is connected directly to the x-y stage and moves over the vials, containers or microwell plates placed underneath, turning the system into a liquid handling robot. In yet other embodiments, a conveyor belt in a processing plant may be controlled by a linear motion module, and reagent vials placed onto the belt may be filled as they pass under a pump head. In some embodiments, sensor or computer vision modules may be combined with motion controller modules and dispensing modules to create a fully automated filling station. Some embodiments may involve actuator modules, incorporating linear actuators or grippers, that can be combined with other motion, sensing, fluid and pneumatic control modules to automate any laboratory or industrial process in a fully scalable format.

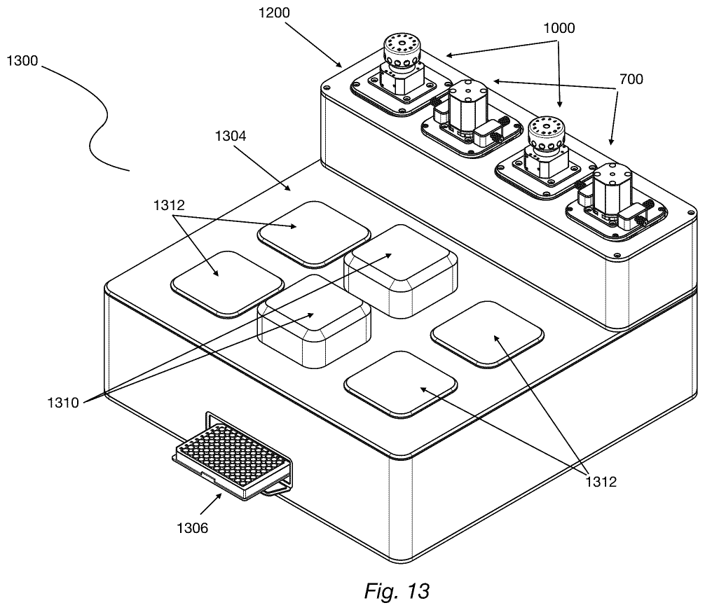

FIG. 13 is an exemplary plate handler setup 1300 with multiple dispensing, sensing and actuation ports, and with the four-unit meta-instrument 1200 from FIG. 12 providing fluidic input. The plate handler meta-instrument 1304 provides an x-y translation stage for a microwell plate 1306 inside a housing. In an embodiment, this housing is similar in shape, material and construction to (albeit potentially larger in size than) that of the individual modules and the housing of the meta-instrument 1200. In other embodiments, the housing may be built like a rectangular box from extruded aluminum frame components. In an embodiment, the plate handler meta-instrument may have its own controller circuitry, and may provide power to the meta-instrument 1302 (and the modules connected to that meta-instrument), as well as other dispensing, sensing 1310 and actuation modules 1312 connected to it. In some embodiments, the optional meta-instrument 1302 may be configured to dispense a variety of reagents through a centrally located dispensing valve manifold 1310, which may incorporate one or more dispensing heads. In other embodiments, the same central ports 1310 on the plate handler meta-instrument may accommodate sensor modules—including, but not limited to, light sensors, fluorescence meters, photomultipliers, camera sensors, and spectrometer units. In an embodiment, the plate handler meta-instrument may also accommodate optional modules 1312 for mechanical actuation (for instance, a cover remover for a microwell plate), thermal incubation, magnetic bead extraction, and mixing. To accommodate interaction with a microwell plate below them, the plate handler optional modules in some embodiments may look different than other modules, with their active external parts facing down below their bottom covers-where their recessed electrical connectors are also located. In alternative embodiments, either the top cover of the plate holder meta-instrument may open or a separate door elsewhere on the instrument housing may enable access to the inside of the plate holder, allowing modules with standard architecture to be plugged inside, under the top cover and above the motion stage, with their active parts facing down towards the motion stage, and/or underneath the motion stage and above the bottom cover, with their active parts facing up towards the motion stage. This architecture allows the user to reconfigure the larger motion stage module with countless different combinations of sensors, actuators, pumps and valves, in order to automate virtually any laboratory or diagnostic assay workflow.

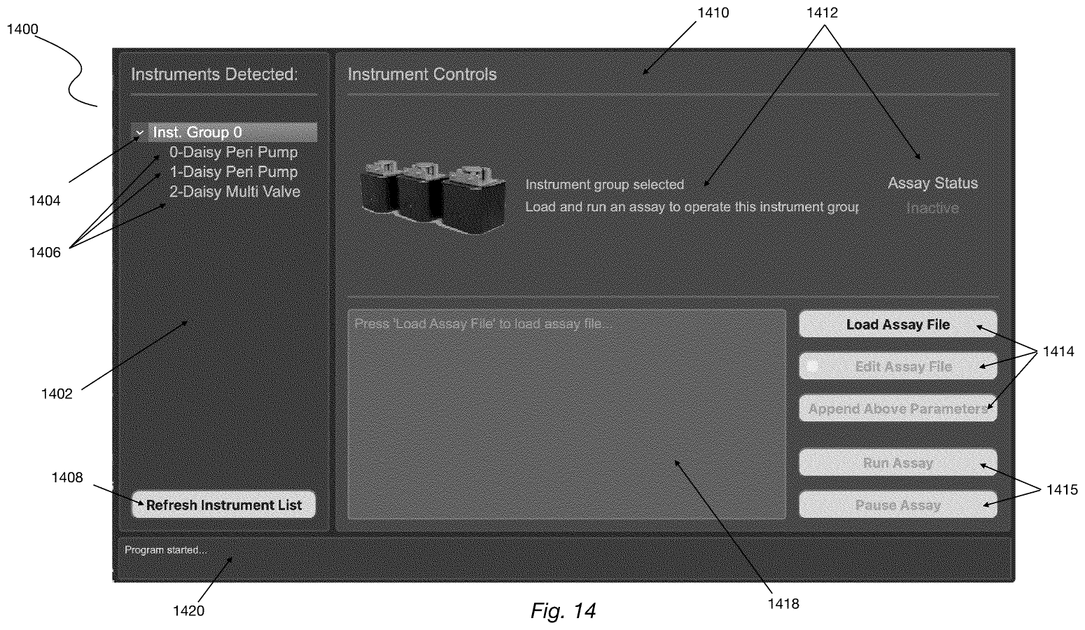

An embodiment of this modular instrumentation system may include an easy-to-use software to interface with the modules and meta-instruments. FIG. 14 shows an exemplary software with a graphical user interface (GUI) 1400 that displays which units are connected and provides a simple way to interact with them. In this embodiment shown in FIG. 14, the left panel of the GUI 1402 may depict the instrument groups 1404 and individual modules 1406 currently connected, as well as their connection order. In some embodiments, the instrument list may be refreshed by the press of a button 1408, which initiates the roll call by the leader module. In other embodiments, the instrument list is refreshed automatically and periodically (such as every second, more often than a second or somewhat less often than a second, up to every ten seconds) whenever the system is idle. In an embodiment, the top half of the right panel of the GUI window 1410 may display control options for the instrument modules and their current status 1412. The bottom half of the right GUI panel may be utilized to create, edit 1414, test and run 1415 automation scripts (referred to in FIG. 14 as “assays”). A large portion of this section of the GUI 1418 may be reserved for the visualization of the assay script. In some embodiments, the GUI may also include a status panel 1420 that reports on the assay and instrument states.

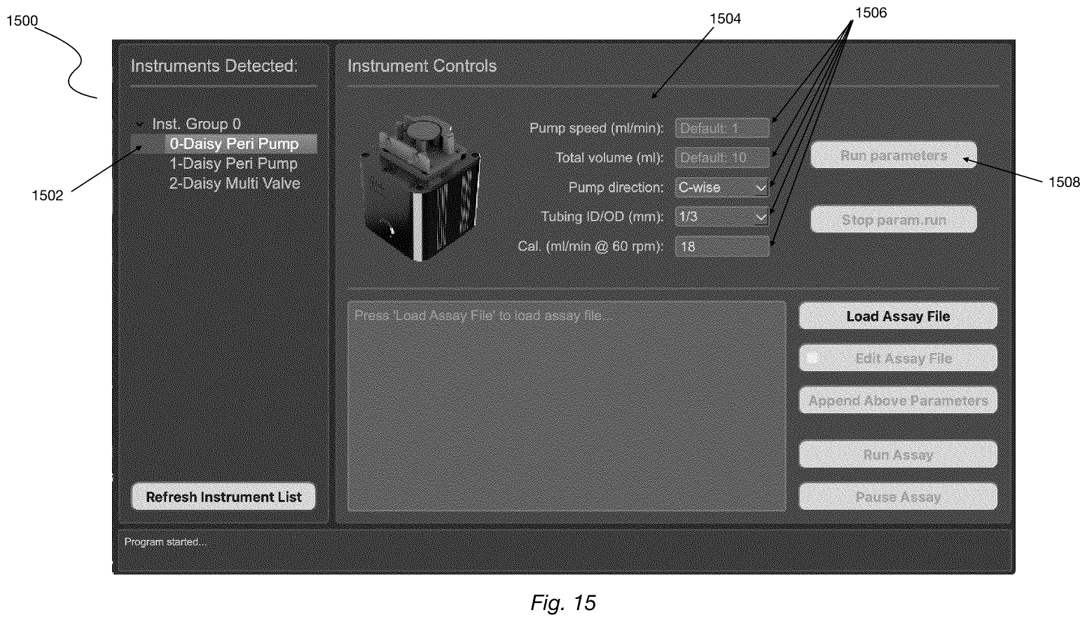

FIG. 15 depicts an exemplary GUI window 1500 which, when an individual module is selected 1502, displays a corresponding virtual control panel 1504 for that module. In this embodiment, the user may enter operational parameters for the module inside edit boxes or pulldown menus 1506. Once all necessary run parameters have been defined, a “run” button may be enabled 1508, allowing the user to start a unit task for the module.

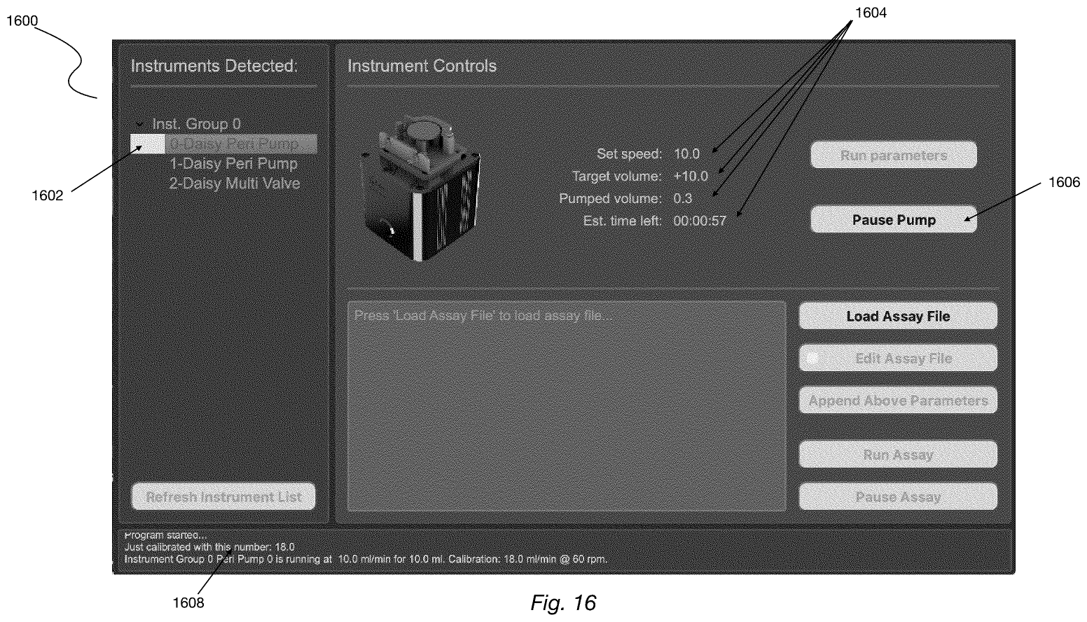

FIG. 16 illustrates an exemplary software 1600 providing real-time feedback in operational parameters 1604 to the user on the virtual control panel as a selected peristaltic pump unit 1602 runs a unit task. In an embodiment, such real-time operational data may include the settings that the user has chosen (such as speed and target pumped volume of fluid for a pump), as well as where the instrument is in its task progression at that moment (for instance, how much fluid volume has been pumped thus far) and the estimated time left in the unit task. In some embodiments, a “pause” button 1606 may be enabled as soon as the unit task is started by the user, and the unit task may be paused by the user at any point. In an embodiment, the pause button, when pressed, may change into a “stop” button, while the button that was previously the “start” button may change into a “continue” button, giving the user the option to either resume the unit task or to stop it altogether. In an embodiment, each instrument module may have its own virtual control panel defined separately in computer code, enabling complete flexibility in the control of different classes of instruments. In some embodiments, a status panel 1608 may report on the status of the unit task running.

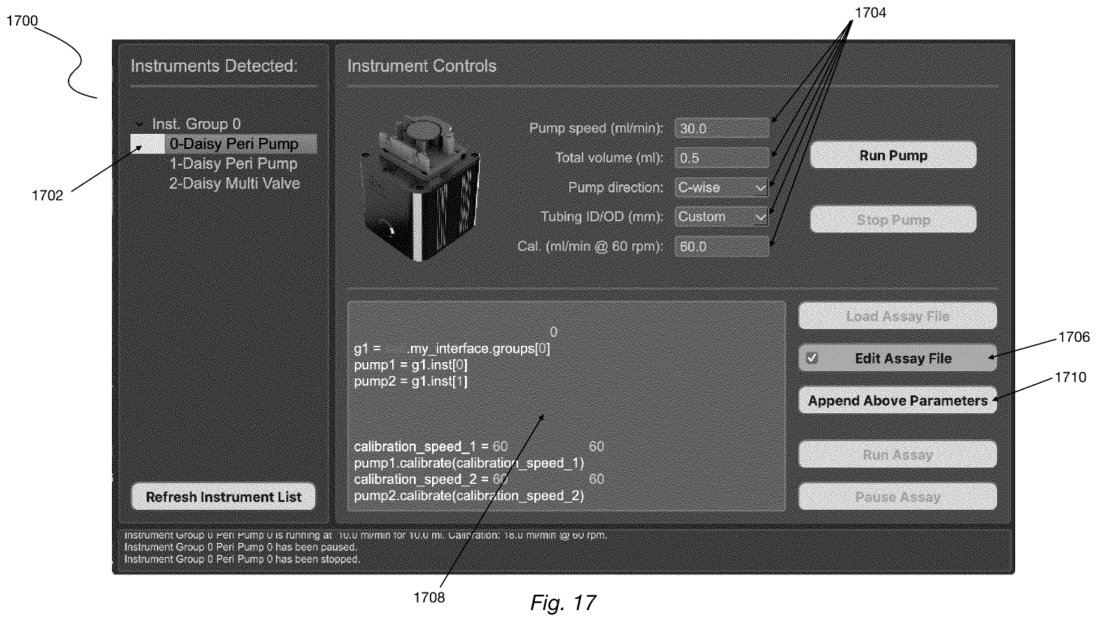

FIG. 17 depicts an exemplary GUI window 1700, in which the operational parameters 1704 of a selected instrument module 1702 may be easily translated to one or more lines of code for rapid automation purposes. In an embodiment, this action may be facilitated by pressing a button 1706 that enables the edit box 1708 containing the eventual assay script, followed by a button that generates the line(s) of code and appends them inside the assay script box. In other embodiments, the assay script may be edited outside the GUI window, if desired. This simple translation from the selected instrument's virtual control panel into an assay scripting and automation tool may dramatically simplify and speed up the user's migration from manual control of a module to full automation within a network of modules and meta-instruments.

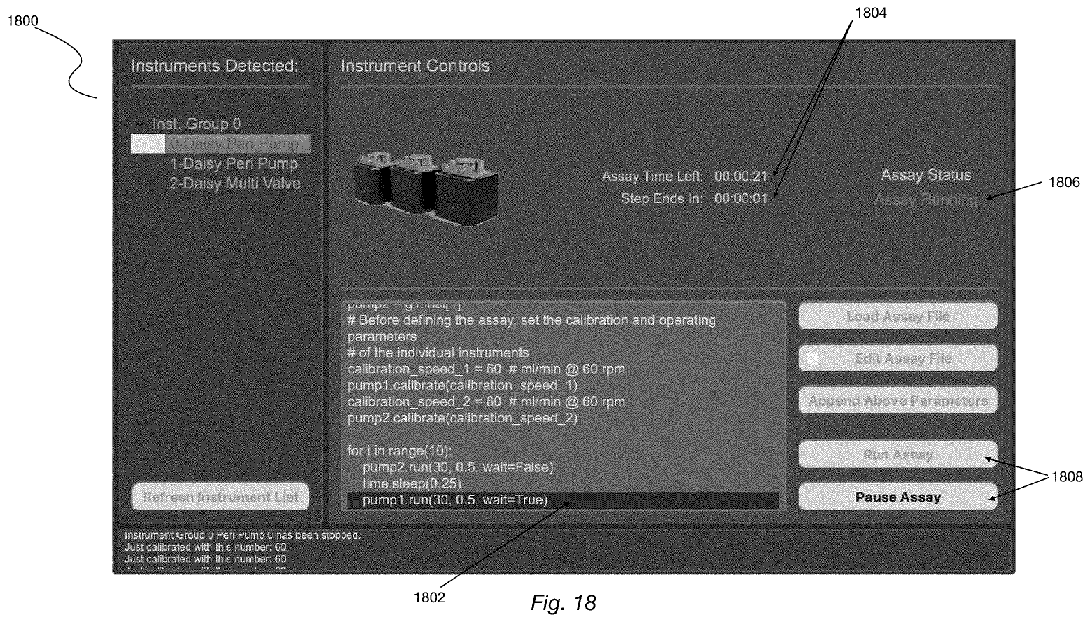

FIG. 18 shows an exemplary GUI window 1800 that demonstrates the capability to easily program a network of instrument modules, with lines of code inside the assay script box being highlighted (in blue) 1802 in real-time as they are executed. In an embodiment, the scripting or programming language may be Python. In other embodiments, the programming language of choice may be JavaScript, or another popular language that is widely and freely available at the time. In yet other embodiments, the scripting language may be custom. In an embodiment, each module may have setup or homing commands, run commands and stop commands defined. For those modules with internal or external sensor connections, additional commands to access sensor data may also be implemented. In some embodiments, the instrument control panel may turn into an assay status panel, reporting on the assay run time 1804 and assay status 1806. In an embodiment, a running assay may be run, paused and stopped using context-sensitive buttons 1808, similar to those used in virtual control panels for individual instrument modules (such as those depicted in FIGS. 15 and 16).

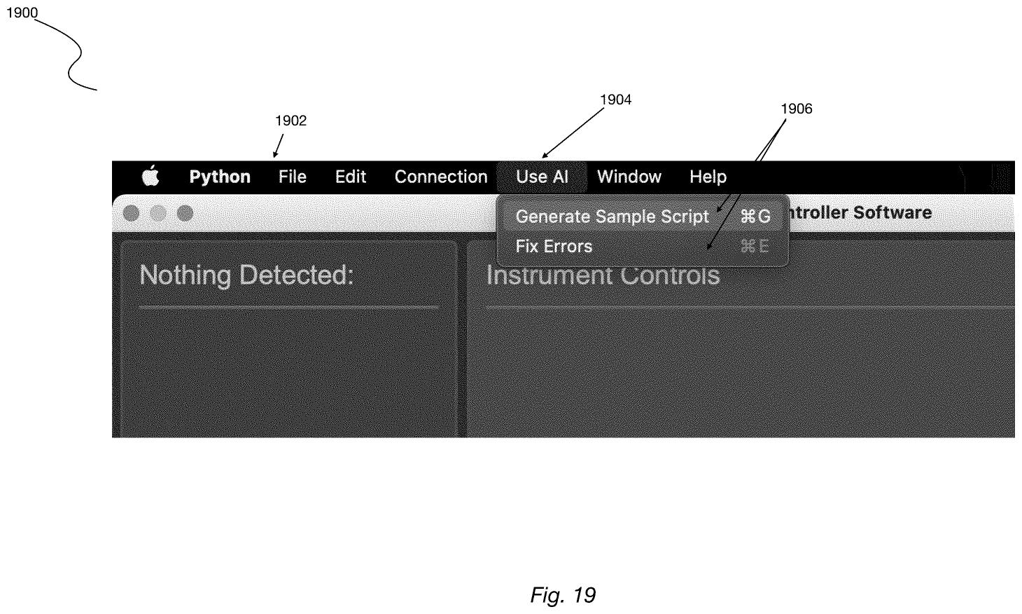

FIG. 19 illustrates an exemplary GUI window 1900 and its main menu 1902 with an option 1904 to use artificial intelligence to provide scripting options or suggest code fixes 1906 for the user's programming effort. In an embodiment, the software may use a generative artificial intelligence (AI) application (such as a large language model, or LLM) and prompt or train it with a sufficient number of script examples so that the AI can automatically generate example scripts for the instrument modules in the network. The same AI interface may also be prompted to look for and fix potential bugs and errors in the user's script. In some embodiments, the AI functionality is available through an application programming interface (API) to a third party offering, such as ChatGPT, Bard or other commercially-available LLMs. In other embodiments, the AI capability may be more specific and limited to the scripting functionality within the GUI, enabling it to be much smaller and, as such, self-contained within the control program. In yet other embodiments, the sample scripts and error fixing capability may be based on a simple, rules-based heuristic algorithm incorporated into the control program.

The following non-limiting examples are provided to illustrate exemplary embodiments of the disclosure.

Example 1 is directed to an instrument module configured to be used either alone or in a networked configuration with other modules. The module comprises an active part—either fluidic, pneumatic, electromechanical or sensory component, a housing that is typically chemically resistant, and a circuit board that drives the active part and interfaces with other modules or an external computer.

Example 2 is directed to the module system of example 1, further comprising the fluidic, pneumatic, actuator or sensory portions of the active part residing outside the top surface of the housing, and the electromechanical driver portions of the active part residing inside the housing.

Example 3 is directed to the module system of example 1, wherein the circuitry and the hardware are configured to allow the modules to be daisy-chained, forming a linear network of automatically self-addressing modules that are controlled by the first module in the daisy-chain, without the need for any additional controller hardware.

Example 4 is directed to the networked modules of example 3, wherein each module can be added to, or removed from, any position in the daisy-chain without having to manually reconfigure the module addresses.

Example 5 is directed to the networked modules of example 3, wherein a given number of modules (for instance, four) can be simply plugged into a larger housing to form meta-instruments that simplify cable and power management.

Example 6 is directed to the meta-instruments of example 5, wherein each meta-instrument can also be daisy-chained with other modules or other meta-instruments in a similar manner to example 3.

Example 7 is directed to the meta-instruments of example 5, wherein some meta-instruments may incorporate linear and rotary motion stages in combination with other fluidic, pneumatic, actuator or sensor modules to control filling processes, biomedical assay runs or manufacturing operations.

Example 8 is directed to a software program that can interface with systems in examples 1, 3, 5 and 7, wherein the software presents user with the status of the network of modules, and the ability to control each one via a virtual control panel.

Example 9 is directed to the software program of example 8, wherein the software can assist the user in rapid transition from manual control of a single module to full automation of all modules in the network—either via translating manual control parameters into short lines of script code via a button press, and/or via the use of artificial intelligence or heuristic algorithms to generate or debug entire automation scripts.

Example embodiments of the devices, systems and methods have been described herein. As noted elsewhere, these embodiments have been described for illustrative purposes only and are not limiting. Other embodiments are possible and are covered by the disclosure, which will be apparent from the teachings contained herein. Thus, the breadth and scope of the disclosure should not be limited by any of the above-described embodiments but should be defined only in accordance with claims supported by the present disclosure and their equivalents. Moreover, embodiments of the subject disclosure may include methods, systems and devices which may further include any and all elements from any other disclosed methods, systems, and devices, including any and all elements corresponding to cartridge securement in a device/system. In other words, elements from one or another disclosed embodiments may be interchangeable with elements from other disclosed embodiments. In addition, one or more features/elements of disclosed embodiments may be removed and still result in patentable subject matter (and thus, resulting in yet more embodiments of the subject disclosure). Correspondingly, some embodiments of the present disclosure may be patentably distinct from one and/or another reference by specifically lacking one or more elements/features. In other words, claims to certain embodiments may contain negative limitation to specifically exclude one or more elements/features resulting in embodiments which are patentably distinct from the prior art which include such features/elements.

This invention has many advantages. It can convert virtually any custom component or commercially available OEM device for fluid/pneumatic control, sensor, actuator or general motion into a highly networkable, easy-to-use and easy-to-scale automation block. Its simple, robust construction reduces cost of ownership, while its scalability and ease of automation dramatically speeds up the pace of innovation in research and development laboratories. The platform also enables significant cost and time savings for increasing throughput in any process or automation setup, allowing users to scale their operations as quickly and proportionally as they need to respond to increases in demand. System engineers may use this platform to more efficiently and quickly test the capabilities of new components and their interactions with other systems. This, in turn, speeds up the development of custom integrated systems that eventually accelerate the pace of innovation in life sciences, chemistry and beyond.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A scalable laboratory and process automation platform comprising:
a first module, the first module comprising:
a first instrument housing, the first instrument housing comprising:
a side shell;
a bottom cover attached to the bottom of the side shell, the side shell generally comprising four walls;
a top cover attached to the top of the side shell;
a power port located in the side shell;
an upstream daisy-chain connection port located in the side shell;
a downstream daisy-chain connection port located in the side shell;
the first instrument housing configured to house any component from the following group of mechanical or electrical components comprising: circuit boards, sensors, motors, solenoids, solenoid valves, rotary valves, heating assemblies, piston pump, fluidic control elements like pumps or valves, pneumatic control elements, air flow controllers, vacuum/air-pressure valves, air/gas pumps, vacuum pumps, piston pump modules, fluidic valves with a piston pump head to provide bidirectional pumping capability, air pressure supply and air flow controller and pneumatic valves being combined with a fluidic manifold and valves to provide a precision liquid and droplet dispensing platform; linear motion stages, rotary motion stages, linear motion module, pump head; sensor modules, computer vision modules, motion controller modules, dispensing modules, actuator modules, linear actuators, grippers, light sensors, fluorescence meters, photomultipliers, camera sensors, microscope heads, spectrometer units, mechanical actuators, cover removers for a microwell plate, thermal incubation modules, magnetic bead extraction modules, and mixing modules;
a first circuit board located inside the first instrument housing and mounted to the bottom cover, the circuit board in communication with the power port, the upstream daisy-chain connection port, the downstream daisy-chain connection port, and the component.

2. The scalable laboratory and process automation platform of claim 1 further comprising:
a second module, the second module comprising:
a second instrument housing, the second instrument housing comprising:
a side shell;
a bottom cover attached to the bottom of the side shell, the side shell generally comprising four walls;
a top cover attached to the top of the side shell;
a power port located in the side shell;
an upstream daisy-chain connection port located in the side shell;
a downstream daisy-chain connection port located in the side shell;
the second instrument housing configured to house any component from the following group of mechanical or electrical components comprising: circuit boards, sensors, motors, solenoids, solenoid valves, rotary valves, heating assemblies, piston pump, fluidic control elements like pumps or valves, pneumatic control elements, air flow controllers, vacuum/air-pressure valves, air/gas pumps, vacuum pumps, piston pump modules, fluidic valves with a piston pump head to provide bidirectional pumping capability, air pressure supply and air flow controller and pneumatic valves being combined with a fluidic manifold and valves to provide a precision liquid and droplet dispensing platform; linear motion stages, rotary motion stages, linear motion module, pump head; sensor modules, computer vision modules, motion controller modules, dispensing modules, actuator modules, linear actuators, grippers, light sensors, fluorescence meters, photomultipliers, camera sensors, microscope heads, spectrometer units, mechanical actuators, cover removers for a microwell plate, thermal incubation modules, magnetic bead extraction modules, and mixing modules;
a second circuit board located inside the second instrument housing and mounted to the bottom cover, the second circuit board in communication with the power port, the upstream daisy-chain connection port, the downstream daisy-chain connection port, and the component; and
the second module is configured to be in communication with the first module via the upstream and/or downstream daisy-chain connection port, and the first module configured to act as the leader module of the modules daisy-chained together.

3. The scalable laboratory and process automation platform of claim 2 further comprising:
an nth module, the nth module comprising:
an nth instrument housing, the nth instrument housing comprising:
a side shell;
a bottom cover attached to the bottom of the side shell, the side shell generally comprising four walls;
a top cover attached to the top of the side shell;
a power port located in the side shell;
an upstream daisy-chain connection port located in the side shell;
a downstream daisy-chain connection port located in the side shell;
the nth instrument housing configured to house any component from the following group of mechanical or electrical components comprising: circuit boards, sensors, motors, solenoids, solenoid valves, rotary valves, heating assemblies, piston pump, fluidic control elements like pumps or valves, pneumatic control elements, air flow controllers, vacuum/air-pressure valves, air/gas pumps, vacuum pumps, piston pump modules, fluidic valves with a piston pump head to provide bidirectional pumping capability, air pressure supply and air flow controller and pneumatic valves being combined with a fluidic manifold and valves to provide a precision liquid and droplet dispensing platform; linear motion stages, rotary motion stages, linear motion module, pump head; sensor modules, computer vision modules, motion controller modules, dispensing modules, actuator modules, linear actuators, grippers, light sensors, fluorescence meters, photomultipliers, camera sensors, microscope heads, spectrometer units, mechanical actuators, cover removers for a microwell plate, thermal incubation modules, magnetic bead extraction modules, and mixing modules;
an nth circuit board located inside the nth instrument housing and mounted to the bottom cover, the nth circuit board in communication with the power port, the upstream daisy-chain connection port, the downstream daisy-chain connection port, and the component;
the nth module is configured to be in communication with the first module and second module via the upstream and/or downstream daisy-chain connection port, and the first module configured to act as the leader module of the modules daisy-chained together;
wherein n is an integer greater than 2.

4. The scalable laboratory and process automation platform of claim 3, further comprising a second data bus in communication with the first, second, and third modules.

5. The scalable laboratory and process automation platform of claim 4, further comprising a third data bus in communication with the first, second, and third modules.

6. The scalable laboratory and process automation platform of claim 1, wherein the top cover has an opening to accept one or more of mechanical or electrical components comprising: circuit boards, sensors, motors, solenoids, solenoid valves, rotary valves, heating assemblies, piston pump, fluidic control elements like pumps or valves, pneumatic control elements, air flow controllers, vacuum/air-pressure valves, air/gas pumps, vacuum pumps, piston pump modules, fluidic valves with a piston pump head to provide bidirectional pumping capability, air pressure supply and air flow controller and pneumatic valves being combined with a fluidic manifold and valves to provide a precision liquid and droplet dispensing platform; linear motion stages, rotary motion stages, linear motion module, pump head; sensor modules, computer vision modules, motion controller modules, dispensing modules, actuator modules, linear actuators, grippers, light sensors, fluorescence meters, photomultipliers, camera sensors, microscope heads, spectrometer units, mechanical actuators, cover removers for a microwell plate, thermal incubation modules, magnetic bead extraction modules, and mixing modules.

7. The scalable laboratory and process automation platform of claim 1, wherein the side shell has an LED, LCD or an electronic ink screen in communication with the first circuit board.

8. The scalable laboratory and process automation platform of claim 1, wherein the first module is configured to communicate with a computer.

9. A scalable laboratory and process automation platform comprising:
a meta-instrument housing, configured to house a plurality of modules;
a backplane located in the meta-instrument housing;
each of the plurality of modules comprising:
an instrument housing, the first instrument housing configured to house any component from the following group of mechanical or electrical components comprising: circuit boards, sensors, motors, solenoids, solenoid valves, rotary valves, heating assemblies, piston pump, fluidic control elements like pumps or valves, pneumatic control elements, air flow controllers, vacuum/air-pressure valves, air/gas pumps, vacuum pumps, piston pump modules, fluidic valves with a piston pump head to provide bidirectional pumping capability, air pressure supply and air flow controller and pneumatic valves being combined with a fluidic manifold and valves to provide a precision liquid and droplet dispensing platform; linear motion stages, rotary motion stages, linear motion module, pump head; sensor modules, computer vision modules, motion controller modules, dispensing modules, actuator modules, linear actuators, grippers, light sensors, fluorescence meters, photomultipliers, camera sensors, microscope heads, spectrometer units, mechanical actuators, cover removers for a microwell plate, thermal incubation modules, magnetic bead extraction modules, and mixing modules;
wherein each of the modules are in communication with each other through connections with the backplane.

10. The scalable laboratory and process automation platform of claim 9 further comprising:
a motion stage meta-instrument housing in communication with the meta-instrument housing and modules, with motion stage meta-instrument housing comprising:
an x-y translation stage for shuttling loads;
one or more flow control modules, sensing modules, or actuation modules configured to act on the x-y translation stage.

11. The scalable laboratory and process automation platform of claim 1, further comprising:
a software interface configured to control the module.

12. The scalable laboratory and process automation platform of claim 11, wherein the software interface further comprises:
a graphical user interface configured to displays which modules are connected;
a graphical user interface button which is configured to when pressed refreshes an instrument list by initiates a roll call by a leader module;
a graphical user interface configured to display control options for the modules and their current status;
a graphical user interface panel configured to allow for the creation, editing, testing and running of automation scripts.

13. The scalable laboratory and process automation platform of claim 11, wherein the software interface further comprises:
a graphical user interface window configured such that when an individual module is selected, the graphical user interface window displays a corresponding virtual control panel for that module.

14. The scalable laboratory and process automation platform of claim 11, wherein the software interface is configured to translate the operational parameters of a selected module to one or more lines of code for rapid automation purposes.

15. The scalable laboratory and process automation platform of claim 11, wherein the software interface is configured to program a network of modules with lines of code inside an assay script box in real-time as they are executed.

16. The scalable laboratory and process automation platform of claim 11, wherein the software interface is configured to use artificial intelligence to provide scripting options or suggest code fixes for module programming.

17. The scalable laboratory and process automation platform of claim 16, wherein the software interface is further configured to use a generative artificial intelligence (AI) application and prompt or train the AI with a sufficient number of script examples so that the AI can automatically determine which modules are needed where in a network for a given task, and generate example scripts for the modules in the network, as well as debug existing scripts.

18. The scalable laboratory and process automation platform of claim 10, wherein the loads are selected from the group consisting of microwell plates, sample holders, and liquid dispensing heads.
